(19) United States
(12) Patent Application Publication
(10) Pub. No.: US 2003/0106435 A1
(43) Pub. Date: Jun. 12, 2003

(54) Display device for container

(76) Inventor: Lawrence J. Koncelik JR., East Hampton, NY (US)

Correspondence Address: Mr. Walter J. Tencza Jr., Suite 3, 10 Station Place, Metuchen, NJ, 08840, US

(21) Appl. No.: 10/346,547

(22) Filed: Jan. 17, 2003

Related U.S. Application Data
(63) Continuation-in-part of application No. 09/967,544, filed on Oct. 1, 2001.

(51) Int. Cl. A23L 1/00; A47J 37/12

(52) U.S. Cl. 99/342; 99/403

(57) ABSTRACT

An apparatus is disclosed comprising a display device. The apparatus may also be comprised of a container onto which the display device can be placed. The display device can be placed in a first or a second state. In the first state the display device provides a first visual indication of a first type of material, which is within the container. In the second state the display device provides a second visual indication of a second type of material, which is within the container. The display device may be comprised of a sliding member for allowing or preventing a first or a second designation for a first or a second type of material to be displayed. The beverage pitcher in one embodiment is a container. The first type of material may be gasoline and the second type of material may be a mixture of gasoline and oil.

### CROSS REFERENCE TO RELATED APPLICATION

The present application is a continuation in part of and claims the priority of parent application Ser. No. 09/967,544, titled “DISPLAY DEVICE FOR BEVERAGE PITCHER OR COFFEE MACHINE”, filed on Oct. 1, 2001, applicant Lawrence J. Koncelik, Jr.

### FIELD OF THE INVENTION

This invention relates to improved methods and apparatus concerning providing signs or symbols to indicate the contents of containers.

### BACKGROUND OF THE INVENTION

Containers in the prior art typically do not provide adequate methods or apparatus for identifying contents of types of material contained therein.

### SUMMARY OF THE INVENTION

The present invention in one or more embodiments discloses an apparatus comprising a container and a display device. The display device can be placed in a first state or a second state. In the first state the display device provides a first visual indication of a first type of material, which is within the container. In the second state the display device provides a second visual indication of a second type of material, which is within the container. The first and second types of material differ and the first and second visual indications differ.

The display device may be comprised of a sliding member which is connected to the container and which can be slid to a first position to allow a first designation of the first type of material to be seen and which in the first position covers and prevents from being seen a second designation of the second type of material. The sliding member may also be slid into a second position to allow a second designation of the second type of material to be seen and which in the second position covers and prevents from being seen the first designation of the first type of material.

The display or indicator device may be an attachable/detachable device, which can be attached or detached from a container.

The container may be, for example, a container for holding gasoline or a mixture of gasoline and oil. The container may also be a bin for containing dry goods, a test tube holding a chemical sample, a laboratory decanter for containing a chemical sample, or a beverage container, such as a milk container. In one embodiment, the first type of material may be gasoline while the second type of material may be a mixture of gasoline and oil. The first and second designations of the first and second types of materials may each be comprised of least one alphanumeric character.

The present invention also discloses a method comprising the steps of fixing a display device onto a container wherein the display device can be placed into the first state or the second state previously described.

The present invention in various embodiments allows one to determine whether or not the contents of a container, contain a first type of material or a second type of material.

### BRIEF DESCRIPTION OF THE DRAWINGS

FIG. 1 shows a container with a display device in a first state to indicate a first type of material in the container in accordance with a first embodiment of the present invention;

FIG. 2 shows the container and the display device of FIG. 1 with the display device in a second state to indicate a second type of material in the container in accordance with a first embodiment of the present invention;

FIG. 3 shows a container in accordance with another embodiment of the present invention including an indicator or display device showing a light under a designation to indicate whether a type of material within the container is of a first type or a second type;

FIG. 4 shows a container in accordance with another embodiment of the present invention including an indicator or display device showing only a light, which may be one of two colors, to indicate whether container contains material of a first type or material of a second type;

FIG. 5 shows a container in accordance with another embodiment of the present invention having an indicator or display device which includes a push button and a electronic digital display to indicate whether the container contains material of a first type or a second type;

FIG. 6 shows a container in accordance with another embodiment of the present invention having an indicator or display device which includes a push button and an electronic digital display to indicate whether the container contains a material of a first type or a material of a second type;

FIG. 7 shows a container in accordance with another embodiment of the present invention having an indicator or display device which includes a push button and a manual or mechanical display to indicate whether the container contains a material of a first type or a material of a second type;

FIG. 8 shows a container in accordance with another embodiment of the present invention having an indicator or display device, which includes a dial which can point to one of two designations to indicate whether the container contains a material of a first type or a material of a second type;

FIG. 9 shows a backing of the display device of FIG. 1, with the display device separate from any container;

FIG. 10 shows a container in accordance with another embodiment of the present invention having an indicator or display device, which allows for the insertion of designations;

FIG. 11 shows a designation which can be inserted onto the container of FIG. 10; and

FIG. 12 shows another designation, which can be inserted onto the container of FIG. 10.

### DETAILED DESCRIPTION OF THE DRAWINGS

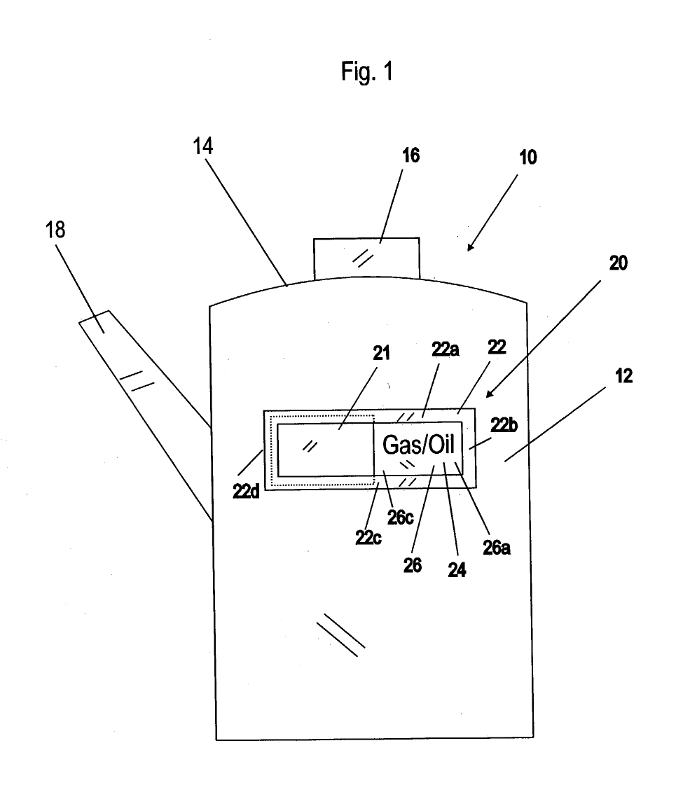

FIG. 1 shows a container 10 with a display device 20 in a first state to indicate a first or second type of material in the container 10 in accordance with a first embodiment of the present invention. Container is a broad term, which includes, any type of container for holding liquids, solids or gasses. For example container includes a gasoline container, a storage bin, a test tube, and any other type of container. In the embodiment of FIG. 1, the container 10 is a gasoline container or gasoline/oil mixture container. The first type of material is a gasoline/oil mixture. A designation 24 in alphanumeric characters of “Gas/oil” is shown as a designation, symbol, or indication, to specify that a mixture of gasoline and oil is in the container 10. The container 10 is also comprised of a receptacle portion 12 for storing liquid such as gas or a gas/oil mixture, a cover portion 14 having a cap 16 for taking off to insert gasoline into the container 10, and a spout 18.

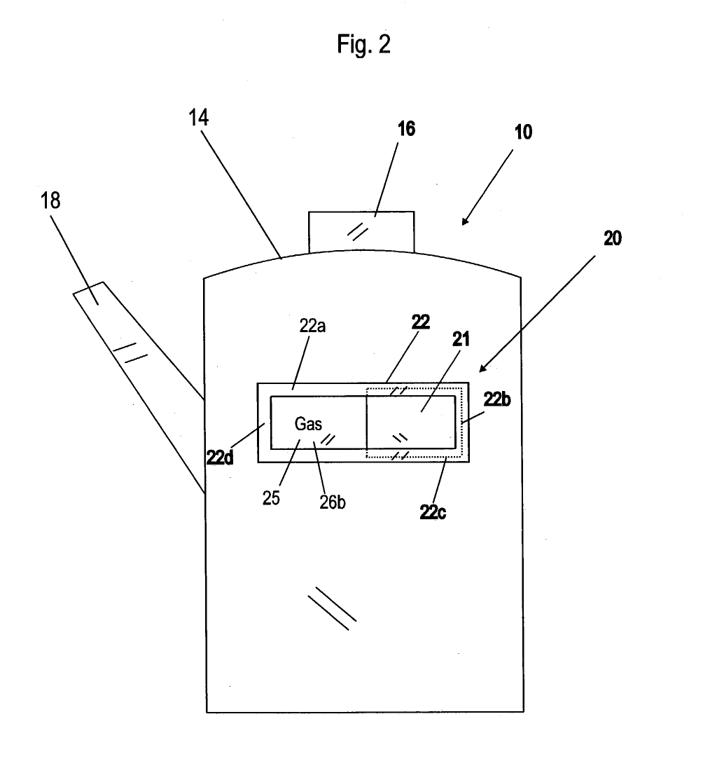

The display device 20 is comprised of a sliding member 21. The sliding member 21 should be opaque so that it covers whatever area it is located over. The display device 20 is also comprised of frame or 22, which includes portions or borders 22a, 22b, 22c, and 22d. The sliding member 21 can slide within frame 22 from a first state or position shown in FIG. 1 to a second state or position shown in FIG. 2. The portion 22d contacts and prevents the sliding member 21 from sliding any further to the left from the first state shown in FIG. 1. The portion 22b contacts and prevents the sliding member 21 from sliding any further to the right from the second state of FIG. 2. The portion 22c keeps the sliding member 21 from falling downwards and the portion 22a keeps the sliding member 21 from moving upwards. In this manner the sliding member 21 is connected or attached to the container 10. Each of the portions or borders 22a-d may have a channel which allow the sliding member 21 to slide underneath a portion of the borders 22a-d but which do not allow the sliding member 21 to become separated from the container 10. Each of the portions or borders 22a-d may be fixed to a front side 26c of a backing 26 which may be attached to the container 10 such as by gluing or in a detachable adhesive manner, or in any other known manner.

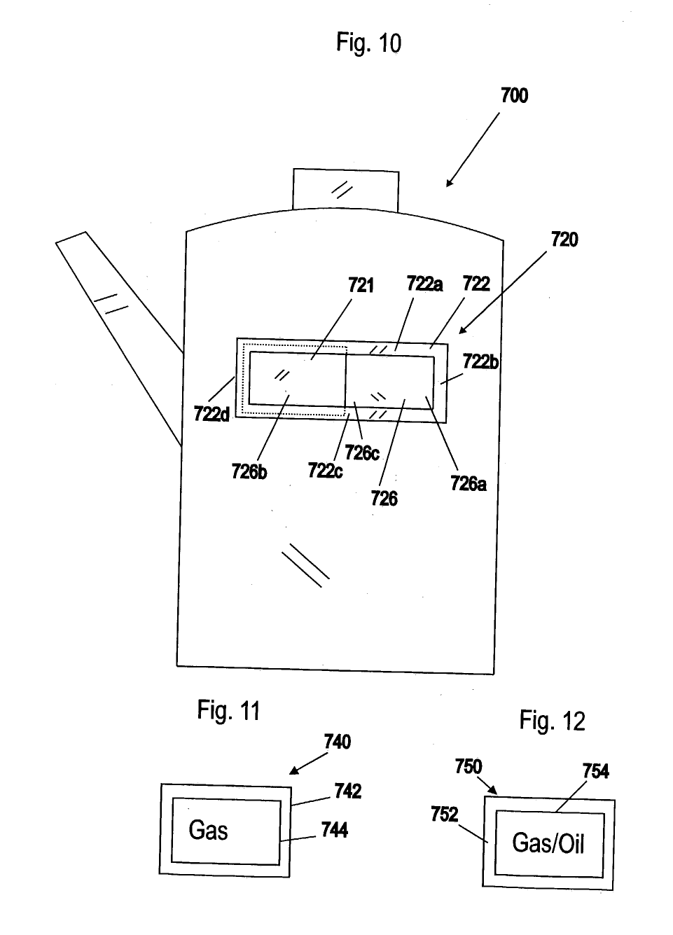

The display device 20 may be sold or provided separately from the container 10. The display device 20 may have a backing 26 with a front side 26c (shown in FIG. 1) and a back side 26d (shown in FIG. 10). On the back side 26d of the backing 26 may be placed an adhesive for attaching or detaching the display device 20 from the pitcher 10. The portions 22a-d, the backing 26, and the sliding member 21 may be integrated together to form the display device 20.

In operation a person, who may be the person inserted and/or filled the container 10 with gasoline or an oil/gas mixture, which is contained in receptacle 12, may place the display device 20 in a first state to indicate that, for example, gasoline, is in the container 10. In this first state, shown in FIG. 1, the designation 24 “Gas/Oil” can be seen. This can be called a first visual indication of a first type of material within the container 10. The designation 24 “Gas/Oil” may be printed on a portion 26a of the backing 26. In the first state, the designation 25 “Gas” (shown in FIG. 2) is covered by the opaque sliding member 21, which has been slid completely to the left in FIG. 1.

An individual may change the display device 20 into a second state to indicate that a second type of material (which differs from the first type of material) is in the container 10. The individual would slide the sliding member 21 from the position in FIG. 1 to the position in FIG. 2. The edges of the sliding member 21 underneath the frame 22 are shown by dashed lines in FIGS. 1 and 2. In the second state of FIG. 2, the sliding member 21 has been slid as far to the right as it can be slid, until it contacts portion 22b of the frame 22. The sliding member 21 now covers the designation 24 for “Gas/Oil” and the designation 25 for “Gas” can be seen. This can be called a second visual indication of a second type of material within the container 10. The designation 25 for “Gas” is printed on a portion 26b of the backing 26. The backing 26 may be a material such as plastic or hard cardboard. Instead of the “Gas/Oil” and the “Gas” designations for designations 24 and 25, the designations 24 and 25 may be for example (a) “acid” and “base”, (b) “milk” and “half & half”, (c) “sifted flour” and “un-sifted flour”, or (d) “sugar” and “saccharine”. Although the designations 24 and 25 will typically relate to the contents of the container, in one or more embodiments the designations 24 and 25 may not relate to the contents of the container. For example, if the container is a coffee mug, the designations 24 and 25 may merely show messages desired to be displayed by the user. For example, the designations 24 and 25 may be (a) “good mood” and “bad mood”, (b) “don't speak to me” or “I'm lonely and want to talk”.

The display device 20 may take on other forms. Other liquids or solids could be placed in the container 10. For example container 10 may instead be a box, which contains dry goods.

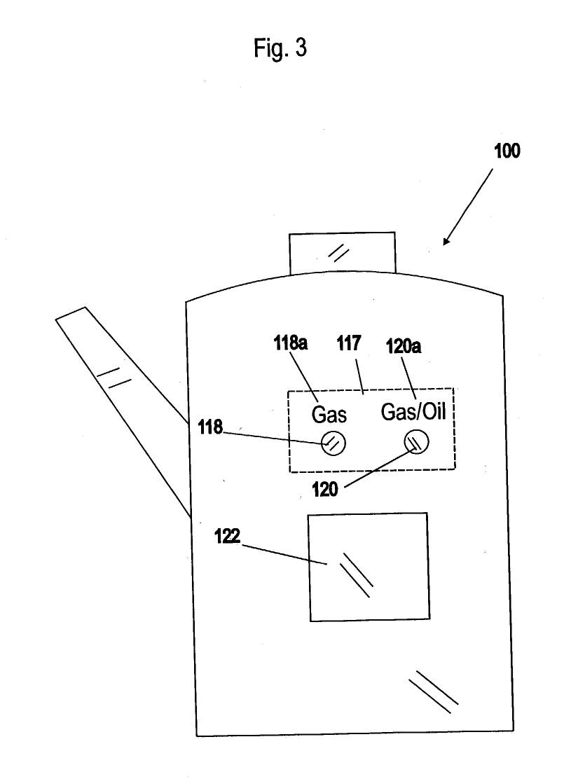

FIG. 3 shows a container 100 in accordance with another embodiment of the present invention. The container 100 includes an indicator device 117 and a control panel 122. The container 100 may be similar to the container 10 of FIGS. 1 and 2. However, the indicator device 118 of FIG. 3 has replaced the display device 20 of FIGS. 1 and 2.

The indicator device 117 includes push button lights 118 and 120, which are under designation “Gas” 118a, and “Gas/Oil” 120a respectively. The push button lights 118 and 120 are both toggle switches and as such if they are turned off, they will light up when pushed, and if they are turned on, they will turn off when pushed in. If an individual has placed gasoline only in the container 100 then they may cause the push button light 118 to light and cause the push button light 120 to stay off. Thus light 118 is lit under designation 118a for “Gas”. If an individual has placed a gas/oil mixture in the container 100 they may cause the push button light 118 to turn off and cause the push button light 120 to stay on. Thus light 120 is lit under designation 120a for “Gas/Oil”. In this way, any person who wants to use the material inside the container 100 will know whether the material is gas or a gas/oil mixture.

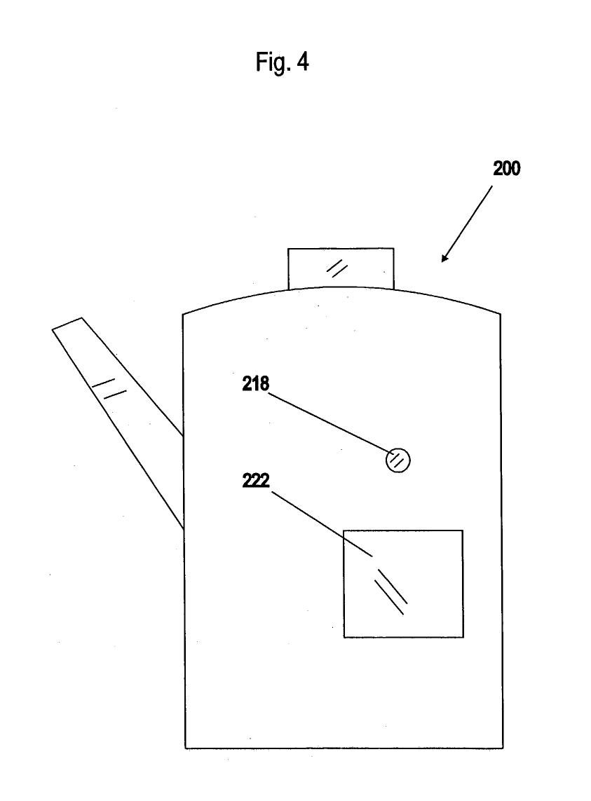

FIG. 4 shows a container 200 in accordance with another embodiment of the present invention including an indicator device 218 which is only a light in this example and which may emit one of two colors, to indicate whether material which has been placed in the container 200 is of a first type or a second type. The container 200 may be identical to the container 100 except for the difference between indicator device 117 and the indicator device 218.

The indicator device 218 is a push button single light, which can be toggled to emit either a green color light or a red color light. An individual can use, for example, green to indicate that gas only is in the container 200 and red to indicate that a gas/oil mixture is in the container 200.

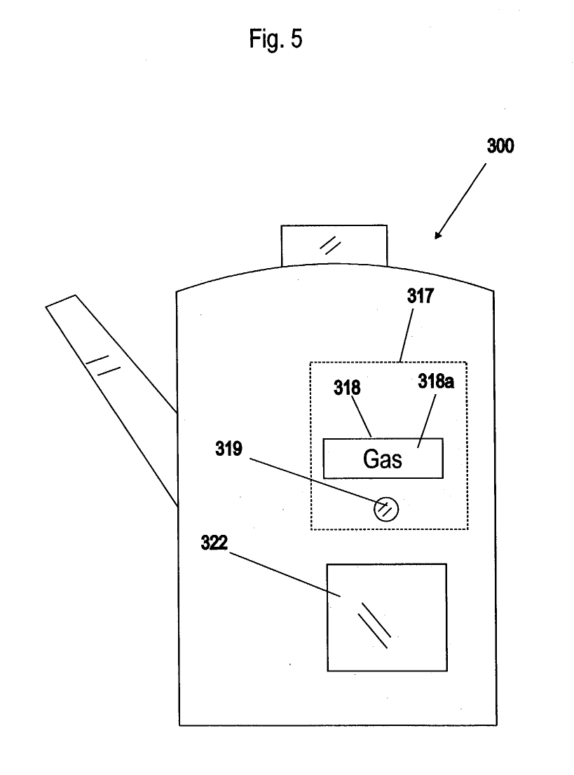

FIG. 5 shows a container 300 in accordance with another embodiment of the present invention having an indicator device 317, which includes a push button 319, and a electronic digital display 318 to indicate what type of material is in the container 300. The container 300 may be identical to the container 200 except for the difference between indicator device 218 and the indicator device 317. The container 300 includes the indicator device 317 and a control panel 322.

An individual can set the electronic digital display 318 to a “Gas” 318a designation as in FIG. 5 by pressing the push button 319 a certain number of times. When the push button 319 is next pressed the designation on the digital display 318 may turn to a “Gas/Oil” designation. The push button 319 may be a toggle switch, which toggles the “Gas” and “Gas/Oil” designations on the display 318.

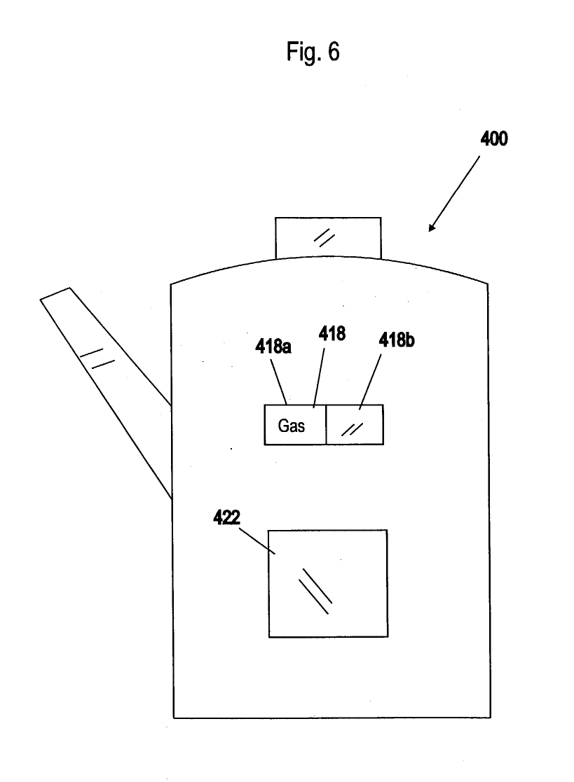

FIG. 6 shows a container 400 in accordance with another embodiment of the present invention having an indicator device 418. The container 400 may be identical to the container 300 except for the difference between indicator device 418 and the indicator device 317. The container 400 may include a control panel 422.

The indicator device 418 is a slide display, which may be identical to the display device 20 in FIG. 1. The indicator device 418 may be provided or sold separately from the container 400. The indicator device 418 may have an adhesive backing, which can be attached or detached to or from the container 400. An individual can set the indicator device 418 to show the “Gas” designation 418a and to cover the “Gas/Oil” designation with panel 418b or may cover the “Gas” designation 418a and show the “Gas/Oil” designation depending on the type of material in the container 400.

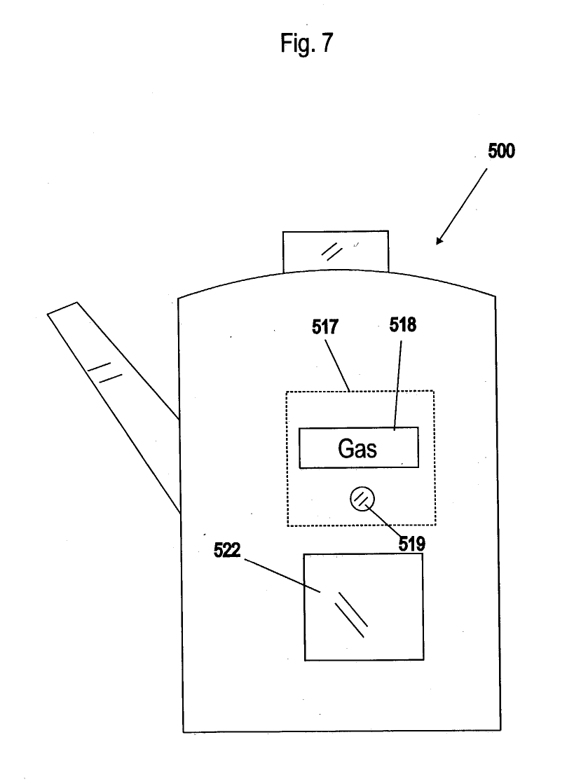

FIG. 7 shows a container 500 in accordance with another embodiment of the present invention having an indicator device 517. The container 500 may be identical to container 400 except for the difference between indicator device 517 and the indicator device 418. Container 500 includes control panel 522.

The indicator device 517 is comprised of a display 518, which manually or mechanically changes, and a push button switch 519 for changing the mechanical display. An individual can mechanically toggle the mechanical display to show either a “Gas” designation or a “Gas/Oil” or designation, for example, with the switch 519, depending on the type of material in the container 500.

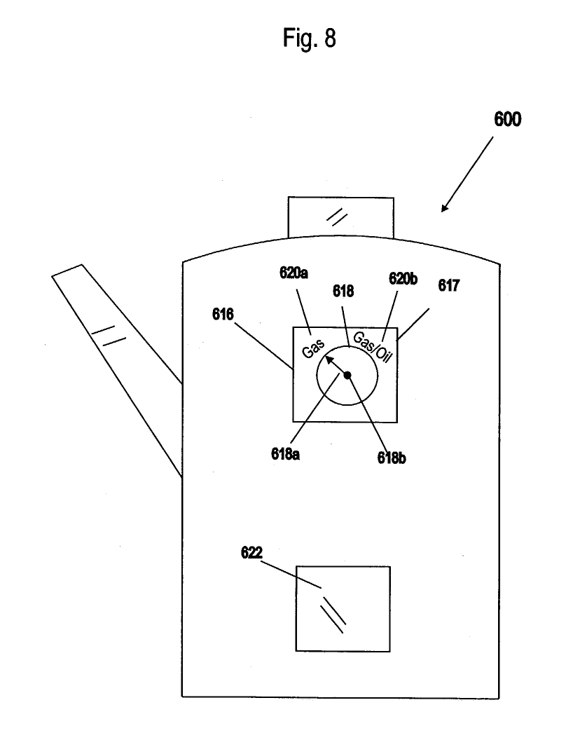

FIG. 8 shows a container 600 in accordance with another embodiment of the present invention having an indicator device 617. The container 600 may be identical to container 500 except for the difference between indicator device 617 and the indicator device 517. Container 600 includes a control panel 622.

The indicator device 617 is comprised of a dial 618 which includes a pointer 618a, and designations 620a for “Gas” and 620b for “Gas/Oil”. The pointer 618a can be rotated about pivot point 618b which may be a knob, and the pointer 618a can be set to point to either the designation 620a or the designation 620b depending on the type of material in container 600.

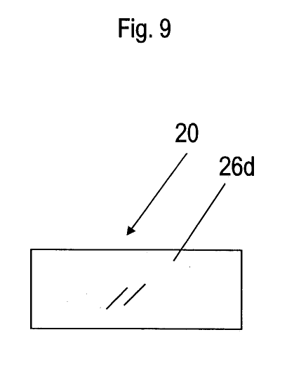

FIG. 9 shows a back side 26d of a backing 26 of the display device 20 of FIG. 1, with the display device 20 separate from any container. The back side 26d may be made of an adhesive material or may have an adhesive material placed thereon.

FIG. 10 shows a container 700 in accordance with another embodiment of the present invention having an indicator or display device 720, which allows for the insertion of designations or attachment devices having designations. The display device 720 may be the same as the display device 20 of FIGS. 1 and 2, with the exception that the display device 720 does not have any designations, but allows for the insertion of designations.

The display device 720 may be comprised of a sliding member 721. The sliding member 721 should be opaque so that it covers whatever area it is located over. The display device 720 is also comprised of frame or 722, which includes portions or borders 722a, 722b, 722c, and 722d. The sliding member 721 can slide within frame 722 from a first state or position shown in FIG. 10 to a second state or position (similar to the state shown in FIG. 2). The portion 722d contacts and prevents the sliding member 721 from sliding any further to the left from the first state shown in FIG. 10. The portion 722b contacts and prevents the sliding member 721 from sliding any further to the right (similar to as shown in FIG. 2). The portion 722c keeps the sliding member 721 from falling downwards and the portion 722a keeps the sliding member 721 from moving upwards. In this manner the sliding member 721 is connected or attached to the container 700. Each of the portions or borders 722a-d may have a channel which allow the sliding member 721 to slide underneath a portion of the borders 722a-d but which do not allow the sliding member 721 to become separated from the container 700. Each of the portions or borders 722a-d may be fixed to a front side 726c of a backing 726 which may be attached to the container 700 such as by gluing or in a detachable adhesive manner, or in any other known manner. The backing 726 may be comprised of a portion 726a and a portion 726b. Portion 726b is under the sliding member 721 shown in FIG. 10.

FIG. 11 shows a device 740 comprised of an attachment device 744, which has the designation “Gas”. The attachment device 744 may be a decal or sticker and may be stick to a backing 742 from which the attachment device or sticker 744 can be removed. The attachment device 744 can be removed from the backing 742 and placed onto the portion 726a or the portion 726b.

Similarly, FIG. 12 shows a device 750 comprised of an attachment device 754, which has the designation “Gas/Oil”. The attachment device 754 may be a decal or sticker and may be stick to a backing 752 from which the attachment device or sticker 754 can be removed. The attachment device 754 can be removed from the backing 752 and placed onto the portion 726a or the portion 726b of the indicator device 720. Typically, the “Gas” designation (attachment device 744) will be placed on one of the portions 726a or 726b, while the “Gas/Oil” designation (attachment device 754) will be placed on the other of the portions 726a or 726b. In this manner any type of designations can be applied to the container 700 by the use of appropriate attachment devices. Instead of decals for the attachment devices 744 and 754, programmable display units (similar to thin calculators) may be provided to attach to the container 700. In addition, blank attachment devices, instead of 744 and 754, can be used which allow someone to write in different designations.

Although the invention has been described by reference to particular illustrative embodiments thereof, many changes and modifications of the invention may become apparent to those skilled in the art without departing from the spirit and scope of the invention. It is therefore intended to include within this patent all such changes and modifications as may reasonably and properly be included within the scope of the present invention's contribution to the art.

I claim:

1. An apparatus comprising:
a display device;
wherein the display device can be placed in a first state or a second state; and
wherein when the display device is placed in a first state the display device provides a first visual indication of a first type of material, which is within a container;
wherein when the display device is placed in a second state the display device provides a second visual indication of a second type of material, which is within the container;
wherein the first and second types of material differ and the first and second visual indications differ; and
wherein the display device can be attached or detached from the container.

2. The apparatus of claim 1
wherein first and second attachment devices can be attached to the display device to provide the first and second visual indications, respectively.

3. An apparatus comprising:
a display device;
wherein the display device can be placed in a first state or a second state; and
wherein when the display device is placed in a first state the display device provides a first visual indication of a first type of material, which is within a container;
wherein when the display device is placed in a second state the display device provides a second visual indication of a second type of material which is within a container; and
wherein the first and second types of material differ and the first and second visual indications differ;
wherein the display device is comprised of a sliding member which is connected to the container and which can be slid to a first position to allow a first designation of the first type of material to be seen and which in the first position covers and prevents from being seen a second designation of the second type of material;
and wherein the sliding member can be slid to a second position to allow the second designation of the second type of material to be seen and which in the second position covers and prevents from being seen the first designation of the first type of material.

4. The apparatus of claim 3 wherein
the first visual indication is a designation of the first type of material and is comprised of least one alphanumeric character; and
the second visual indication is a designation of the second type of material and is comprised of at least one alphanumeric character.

5. The apparatus of claim 4 wherein
the container is a container designed to contain gasoline or a mixture of oil and gasoline;
wherein the first type of material is gasoline;
and the second type of material is a mixture of oil and gasoline.

6. An apparatus comprising:
an indicator device comprised of:
a first light under a first designation which when lit provides a first visual indication that a first type of material is present within a container; and
a second light under a second designation which when lit provides a second visual indication that a second type of material is present within the container;
and wherein the first designation is fixed at a first location on the indicator device and the second designation is fixed at a second location on the indicator device, the first location being different from the second location;
and wherein the first light is fixed at a third location on the indicator device and the second light is fixed at a fourth location on the indicator device, the third location being different from the fourth location.

7. The apparatus of claim 6 wherein
the first light is part of a first push button which can be pushed in to light the first light to indicate that the first type of material is present within the container; and
the second light is part of a second push button, which can be pushed in to light the second light to indicate that the second type of material is present within the container.

8. An apparatus comprising:
a container;
a first light, which is able to emit either, a first or a second color light;
wherein the first light emits the first color light when the container contains material of a first type,
wherein the first light emits the second color light when the containers contain material of a second type.

9. The apparatus of claim 8 wherein
the first light is part of a first push button, which can be pushed in to light the first light and to toggle the first light from emitting the first color light to emitting the second color light.

10. An apparatus comprising:
a container;
wherein the container includes an indicator device;
wherein the indicator device indicates whether the container contains a material of a first type or a material of a second type; and
wherein the indicator device includes an electronic digital display, which displays whether the container contains the material of a first type or the material of a second type;
wherein the indicator device includes a first push button which when pushed in causes the electronic digital display to toggle from displaying an indication that the container contains material of a first type to displaying an indication that the container contains material of a second type.

11. The apparatus of claim 1 further comprising
the container.

12. An apparatus comprising:
a container, which includes an indicator device;
wherein the indicator device indicates whether the container contains a first type of material or a second type of material; and
wherein the indicator device includes a dial having a pointer and first and second designations;
wherein the first designation provides an indication that the container contains the first type of material and the second designation provides an indication that the container contains the second type of material;
and wherein the pointer can point to either the first or the second designation to indicate whether the container contains the first type of material or the second type of material.

13. A method comprising the steps of
fixing a display device onto a container; and
wherein the display device can be placed into a first state or a second state;
wherein when the display device is placed in a first state the display device provides a first visual indication of a first type of material, which is within the container;
wherein when the display device is placed in a second state the display device provides a second visual indication of a second type of material which is within the container; and
wherein the first and second types of material differ and the first and second visual indications differ.

14. The method of claim 13 wherein
the display device is comprised of a sliding member which is connected to the container and which can be slid to a first position to allow a first designation of the first type of material to be seen and which in the first position covers and prevents from being seen a second designation of the second type of material.

15. The method of claim 13 wherein
the first type of material is gasoline; and
the second type of material is a mixture of gasoline and oil.

16. The method of claim 13 wherein
the first visual indication is a designation of the first type of material and is comprised of least one alphanumeric character; and
the second visual indication is a designation of the second type of material and is comprised of at least one alphanumeric character.

17. The method of claim 14 wherein
the first visual indication is a designation of the first type of material and is comprised of least one alphanumeric character; and
the second visual indication is a designation of the second type of material and is comprised of at least one alphanumeric character.
